(19) United States
(12) Patent Application Publication
(10) Pub. No.: US 2010/0327488 A1
(43) Pub. Date: Dec. 30, 2010

(54) Method of Making Hollow Concrete Elements

(75) Inventors: Lutfi Ay, Saltsjobaden (SE); Peter Häger, Djursholm (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 12/865,888

(22) PCT Filed: Apr. 22, 2008
(86) PCT No.: PCT/SE2008/050456

§ 371 Date: Aug. 3, 2010

Related U.S. Application Data
(60) Provisional application No. 61/026,247, filed on Feb. 5, 2008.

(51) Int. Cl. B28B 1/44; B29C 41/04

(52) U.S. Cl. 264/312; 425/460

(57) ABSTRACT

A method of making an open ended hollow concrete element includes arranging a mold about a substantially horizontal roller shaft, the mold having a sleeve-shaped mold wall defining the outer peripheral shape of the concrete element and first and second end rims, each with an inner periphery smaller than the inner periphery of the mold wall at the respective end and defining the end surfaces of the concrete element. The mold is rotatably supported by the roller shaft by abutment at the inner peripheries of the first and second end rims so that the roller shaft upon rotation defines the inner peripheral shape of the concrete elements. The method further includes rotating the shaft to rotate the mold; feeding curable concrete to the rotating mold; stopping the rotation of the mold; and removing the cured concrete element from the mold. The inner perimeter of the mold wall defines an exterior shape of the concrete element that varies along and/or radially to the direction of the rotational axis. There is further provided an arrangement for making such concrete elements.

### TECHNICAL FIELD

The present invention generally relates concrete elements, and in particular, to a method and arrangement for making open-ended hollow concrete elements.

### BACKGROUND

Open-ended hollow concrete elements are found in various implementations, mainly as pipes buried under ground, but also as construction elements in buildings, bridges, towers etc.

Elongated reinforced concrete structures are frequently used in a variety of fields. Examples of elongated reinforced concrete structures are different types of masts and towers, pylons, chimneys, architectural structures, arc shaped beams, etc. . . .

Traditionally, such elongated structures are cast moulded on site, either in one single moulding or by several sub sequent moulding steps wherein reinforcement elements of a preceding moulding are integrated in the subsequent moulding to achieve a continuous longitudinal reinforcement structure throughout the structure. However, on site moulding is time and labour consuming, as well as requires transport of Moulding equipment to the site. Moreover it is difficult to achieve full control of the moulding process whereby the material properties of the structure are likely to be suboptimal. As a direct consequence of the sub optimal material properties, the structures must be overdimensioned.

An alternative to on site moulding is prefabrication of segments that are assembled on site. As prefabrication of segments can be performed under well controlled conditions and the whole segment can be moulded in one integral moulding, many of the above disadvantages are avoided.

Patent documents FR2872843, EP1645701 and DE2939472, are some of the documents that describe segmented elongated concrete structures in the form of towers for windturbines, but they fail to describe efficient ways of producing such elements. PCTSE2007/050306 discloses a segmented tower structure and a method for producing such elements and a method for producing such.

Some of the problems with existing solutions and methods are that they are inefficient and that defects and inhomogeneities are difficult to detect before the concrete is hardened.

### SUMMARY

The object of the invention is to provide a new method and arrangement of making an open ended hollow concrete element which overcomes the drawbacks of the prior art. This is achieved by the method and arrangement as defined in the independent claims.

The disclosed method of making an open ended hollow concrete element comprising the steps:
arranging a mould about an essentially horizontal roller shaft, the mould comprising a sleeve-shaped mould wall defining the outer peripheral shape of the concrete element and a first and a second end rim each with an inner periphery smaller than the inner periphery of the mould wall at respective end and defining the end surfaces of the concrete element, the mould is rotatably supported by the roller shaft by abutment at the inner peripheries of the first and a second end rims so that the roller shaft upon rotation defines the inner peripheral shape of the concrete elements,
rotating the shaft to rotate the mould,
feeding curable concrete to the rotating mould,
stopping the rotation of the mould,
removing the cured concrete element from the mould,
wherein the inner perimeter of the mould wall defines an exterior shape of the concrete element that varies along and/or radially to the direction of the rotational axis,
   represent a new sort of thinking. There is further provided a new arrangement for making such open ended hollow concrete elements wherein the inner perimeter of the mould wall defines an exterior shape of the concrete element that varies along and/or radially to the direction of the rotational axis. None of the mentioned prior art documents describe such an method or arrangement.

The method and arrangement for making open ended hollow concrete elements has the following advantages, over the prior art.
Results in less porosity, higher concrete density and better durability.
Gives possibility to cast concrete with lower water-cement ratio.
Provides high concrete strengths with low cement content.
Allows high speed of production, approx. 20 min per element.
Allows control of thickness.
Produces essentially no concrete waste during production.
Is flexible for changing the concrete quality and content along the pipe according to our need.
Allows production of nonuniform shapes and aesthetical concrete elements.
   Other embodiments of the invention are defined in the dependent claims.

### BRIEF DESCRIPTION OF THE DRAWINGS

FIGS. 1a and 1b illustrate an example of an elongated concrete structure.

FIG. 2 illustrates another example of an elongated concrete structure.

FIG. 3 illustrates another example of an elongated concrete structure.

FIGS. 4a to 4g illustrate an arrangement for making an open ended hollow concrete element according to one embodiment of the present invention.

FIGS. 5a and 5b show a flow chart of a method for making an open ended hollow concrete element according to one embodiment of the present invention.

FIG. 6 illustrates an arrangement for making an open ended hollow concrete element according to another embodiment of the present invention.

FIG. 7 illustrates an arrangement for making an open ended hollow concrete element according to another embodiment of the present invention.

FIGS. 8a to 8d illustrate an arrangement for making an open ended hollow concrete element according to another embodiment of the present invention.

FIGS. 9a to 9d illustrate an arrangement for making an open ended hollow concrete element according to another embodiment of the present invention.

FIGS. 10a and 10b illustrate arrangements for making open ended hollow concrete elements according to other embodiments of the present invention.

FIG. 11 illustrates an arrangement for making an open ended hollow concrete element according to another embodiment of the present invention.

FIG. 12 illustrates an arrangement for making an open ended hollow concrete element according to another embodiment of the present invention.

FIGS. 13a and 13b illustrate an arrangement for making an open ended hollow concrete element according to another embodiment of the present invention.

FIGS. 14a and 14b illustrate an arrangement for making an open ended hollow concrete element according to another embodiment of the present invention.

FIGS. 15a and 15b illustrate an arrangement for making an open ended hollow concrete element according to another embodiment of the present invention.

FIG. 16 is a flow chart illustrating a method according to an embodiment of the present invention.

FIG. 17 is a block diagram illustrating a system according to an embodiment of the present invention.

### DETAILED DESCRIPTION

The present invention makes it possible to use prefabricated segmented elongated structures as an alternative to structures molded on site or prefab structures molded in one integral piece.

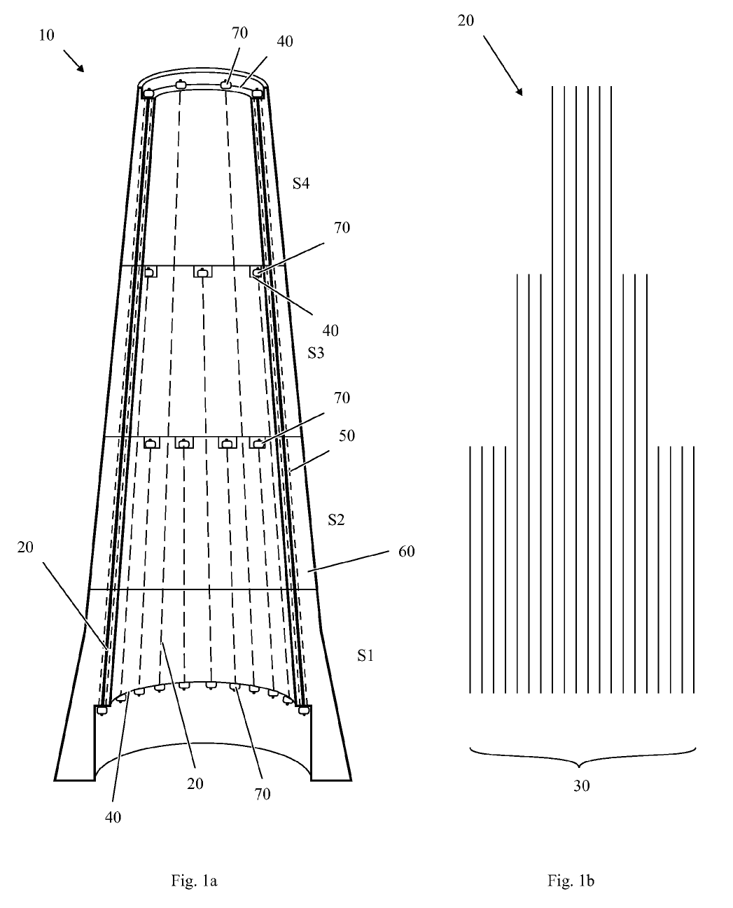

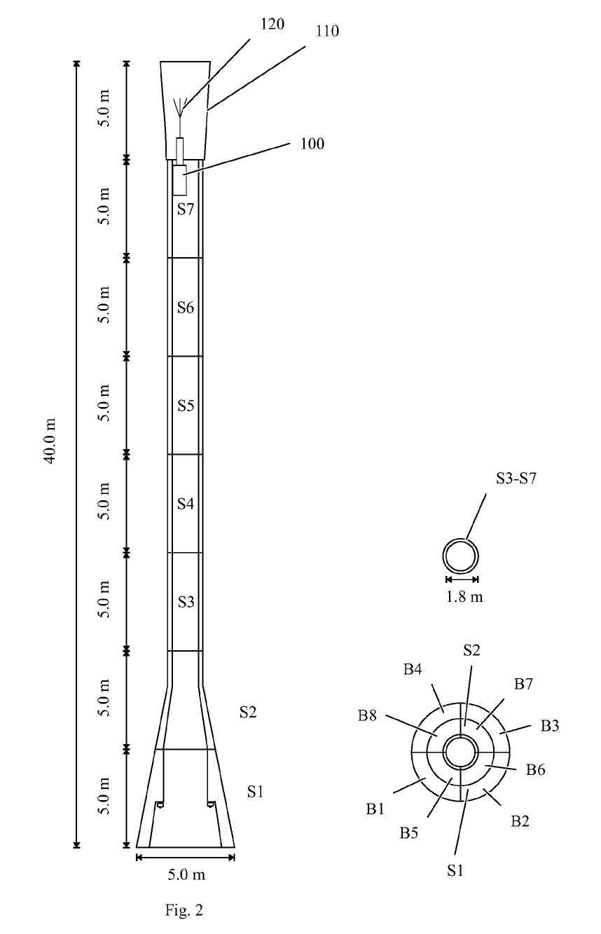

FIGS. 1a and 1b schematically show an elongated structure 10 that is segmented S1-S4 in the longitudinal direction. The elongated structure comprises a base segment S1, at least one intermediate segment S2, S3, and a terminating segment S4 wherein the segments are essentially comprised of reinforced concrete. The segments S1-S4 are interconnected in the longitudinal direction by a plurality of elongated fastening members 20 that together form a longitudinal interconnection structure 30 that interconnect the base segment S1 to the terminating segment S4 without gaps in the longitudinal direction. In alternative terms, the plurality of elongated fastening members 20 together can be said to form a continuous longitudinal interconnection structure 30 throughout the segmented elongated structure 10. As will be disclosed in more detail below, the continuous longitudinal interconnection structure 30 may be of different forms wherein the terminating segment S4 is interconnected to the base segment S1 either directly by one or more fastening members 20 that extends all the way from an attachment point 40 in the base to the terminating segment S4, or indirectly by two or more longitudinally overlapping fastening members 20. Further, Each segment comprises fastening member guides formed in the wall 60 of the segment and arranged to preserve the fastening members 20 at predetermined configuration with respect to said segment.

The embodiment shown in FIGS. 1a and 1b is a thin walled hollow structure, designed to provide desired mechanical properties while being of light weight. Such a thin walled structure provides many advantages relating to structural properties, production and assembly of a segmented elongated structure. However, all or some of the segments may be tick walled or even solid, and sections may even be partially solid.

FIGS. 1a and 1b schematically depict an elongated hollow structure 10 in the form of a tower wherein the base segment S1 is arranged on ground or a foundation or the like (not shown). Depending on a number of parameters such as, the shape of the segments S1-S4, the load to be carried by the structure 10, the conditions where it will be situated, such a tower will be subjected to different types of loads at different segments. Therefore, the continuous longitudinal interconnection structure 30 may be of different form and thus rigidity. One way to define the rigidity of the continuous longitudinal interconnection structure 30 is to define the fastening member 20 density as the number of fastening members at a specific cross section of the elongated structure, i.e. high fastening member density at an intersection between two segments implies that the two segments S1-S4 are secured to each other by a large number of fastening members 20.

In the embodiment of FIGS. 1a and 1b each one of the intermediate segment(s) S2, S3 and the terminating segment S4 is secured to the base segment S1 by three or more fastening members 20. For elongated structures 10 wherein the tension forces in the longitudinal direction are expected to be great in the base region and small in the region of the terminating segment, the embodiment of FIGS. 1a and 1b provides excellent rigidity, as the fastening member density is highest in the base region and decreases towards the terminating segment. In the embodiment of FIG. 1 each segment, except for the base segment S1 and the intermediate segment S2 adjacent the base segment, is secured to a non adjacent segment by three or more fastening members 20.

The fastening member guides 50 are arranged to preserve the fastening members at predetermined configuration in between the attachment points 40. The fastening member guides 50 are formed in the wall of the segments. In order to achieve the continuous longitudinal interconnection structure 30 the fastening member guides 50 of adjacent segments are aligned. In order to facilitate alignment of subsequent segments, adjacent segments may be provided with alignment means (not shown) serving for proper alignment of fastening member guides 50 between adjacent segments. According to one embodiment, the end surfaces of the segments are moulded to the desired form, including access points for fastening member guides and alignment means if present. According to one embodiment, the elongated structure comprises essentially no metal parts exposed to the outer surface.

According to one embodiment, the fastening member guides 50 at least partially are formed as conduits in the wall of the segments. As will be discussed in association with the disclosure of the method of producing segments below, such conduits are preferably formed by placing elongated tubes that extend between attachment point/intersection surfaces in the mould. In the disclosed embodiments, the attachment points 40 are arranged integrally in the wall of the segments so that the fastening members 20 run in an essentially straight line between the attachment points 40. According to one embodiment, the fastening member guides 50 at least partially are formed as grooves in the outer peripheral surface of the segments.

According to one embodiment, the fastening members 20 are comprised as a part of the reinforcement means in the longitudinal direction in the segment(s). The fastening members 20 will act as prestressing reinforcement members in the longitudinal direction. Although it could be possible to completely leave out longitudinal reinforcement means when moulding the segments, reinforcement in the longitudinal direction provides improved rigidity during transport and assembly. The fastening members 20 are made of any suitable material of adequate strength, such as metal bars or wires, fibre reinforced composite rods etc.

The elongated structure may be of essentially any form, eg. straight uniform shape, of varying cross sectional shape along its length, bottle shaped, comprising at least one conical section in the longitudinal direction. According to one embodiment, the elongated structure comprises at least one section is of circular cross section. Examples of other cross sectional shapes comprise oval, triangular, square, starshaped etc.

FIG. 2 show one example of an elongated hollow concrete structure 10 in the form of an antenna tower body adapted to house telecommunications equipment 100. The tower body is comprised of two base sections S1 and S2 comprised of eight sections B1-B8, and a plurality of modular tower segments S3-S7. By forming the base segment of radial sections B1-B8 production and transport of the base section is facilitated. The radial sections B1-B8 are interconnected by suitable radial fastening members. The disclosed embodiment has a circular cross-section, and the base diameter is 5.0 m, whereas the diameter of the modular tower segments is 1.8 m. The antenna tower is provided with a radome 110 and the total height including the radome 110 is 40 m. Moreover, at least two of the segments S3-S7 are essentially identical, whereby they can be subsequently moulded in the same mould. By omitting or adding one or more such “identical” segments S3-S7 towers of different heights can be provided without altering the mould design. According to one embodiment the terminating segment is of the same shape as at least one intermediate segment.

According to one embodiment, a hollow inner portion of the structure 10 has the function of an internal installation shaft, and wherein the tower is arranged to house a radio base station 100 in the installation shaft in the vicinity of one or more associated antennas 120 at the top of the tower body. The tower body and the installation shaft may have a larger cross-sectional area at the base compared with the top. The radio base station provided in the tower belongs to a GSM, WCDMA, HSPA, MIMO, LTE or future type telecommunications system.

The installation shaft may be formed to house one or more radio base stations in the vicinity of one or more associated antennas at the top of the tower body. In order to minimize radio down time the installation shaft is formed to allow personnel access to the radio base station without the need for bringing the base station down. In order for personnel to have adequate access to the RBS, the installation shaft must be large enough so that it is possible for a person occupying the space in front of the RBS to access and perform essentially all normal maintenance and service operations. The volume of the installation shaft by the RBS that is needed to allow adequate access to the RBS equipment depends on the size of the same. According to one embodiment, the RBS equipment in the antenna tower is comprised of standard rack mounted units with a standard width between 60 and 100 cm and a depth of 30 to 80 cm. According to one embodiment, the cross-sectional area of the installation shaft at the radio base station is at least, 2.0, 2.5, 3.0 m² or more. The free space in front of the RBS is at least but not limited to 1.0 to 2.0 m². According to one embodiment, the tower may be of essentially circular cross section at the radio base station height, with a radius of at least 0.7, 0.9, or 1.3 m or more.

According to one embodiment, two or more separate radio base stations are arranged in the installation shaft in the vicinity of one or more associated antennas at the top of the tower body. In order to preserve the limited space in the top section of the tower, the RBSs may be stacked one on top of the other. The RBSs may be of the same type with respect to make and telecommunications system, but they may also belong to different operators or telecommunications systems, e.g. GSM, WCDMA, HSPA, MIMO, LTE or future type telecommunications systems. The antenna tower may also house other types radio communication equipment and associated antennas, such as wireless IP networks etc., as well as radio or television broadcasting equipment.

The installation shaft may extend a limited portion of the height of the tower or all the way from the tower base to the top. In the case the installation shaft extend throughout the full height. The installation shaft may be accessed via an entrance door (not shown) or the like at the lower end thereof, and the RBS is reached by climbing or elevator means inside the shaft.

In FIG. 2 the lower section of tower body is formed as a truncated cone and the upper action as an elongated uniform structure, both of essentially circular cross section. As is discussed more in detail below, the tower body may be of many different shapes. In order to protect the antennas and to establish a controlled environment inside the installation shaft, a radome is arranged extending from the elongated tower body and enclosing the antennas. The radome is designed to give required shelter for the RBS equipment at the same time as it is essentially transparent to radio waves emitted from the antennas.

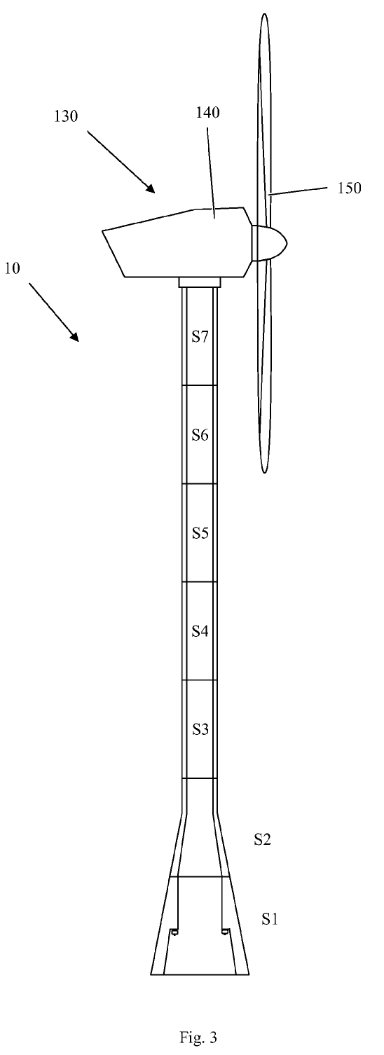

The elongated structure 10 disclosed in FIG. 3 supports a wind turbine unit 130 for production of electrical energy. The wind turbine unit comprises a generator housing 140 with turbine blades 150 pivotally arranged at the top end of the segmented elongated structure 10.

Segments for such elongated concrete structures as well as other concrete structures that are comprised of one or more open-ended hollow concrete elements need to be produced in an efficient way while still ensuring excellent material properties. One relatively successful method of manufacturing open-ended hollow concrete elements in the form of concrete pipe sections is the roller suspension method. This method involves suspending a pipe mould on a rotatable roller shaft which is aligned parallel to the pipe axis. As the roller shaft rotates, the mould, being arranged about and suspended on the roller, rotates about the roller. Concrete is fed into the interior of the mould, as the mould rotates and, since the mould is suspended on the roller, the concrete is compacted in the nip between the inner surface of the mould and the outer surface of the roller resulting in a well compacted concrete and a relatively smooth pipe of uniform thickness. The roller suspension method of pipe formation is well known and need not to be described herein in any greater detail. See for example publication WO9836886 A1 and GB1391763. However, the present roller suspension methods are limited to the production of cylindrically shaped pipe sections of uniform cross-section.

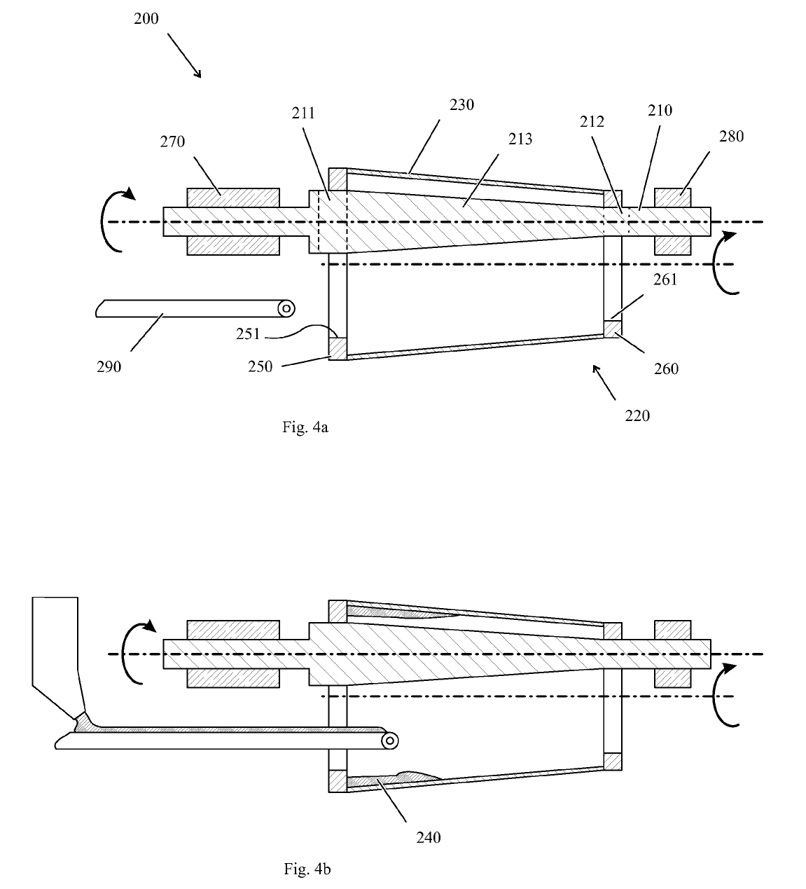

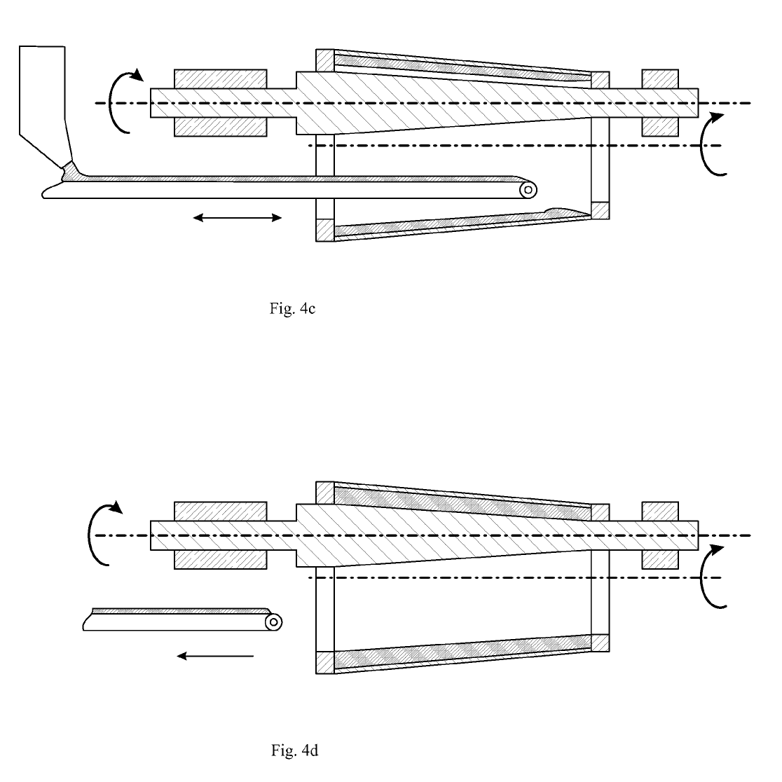

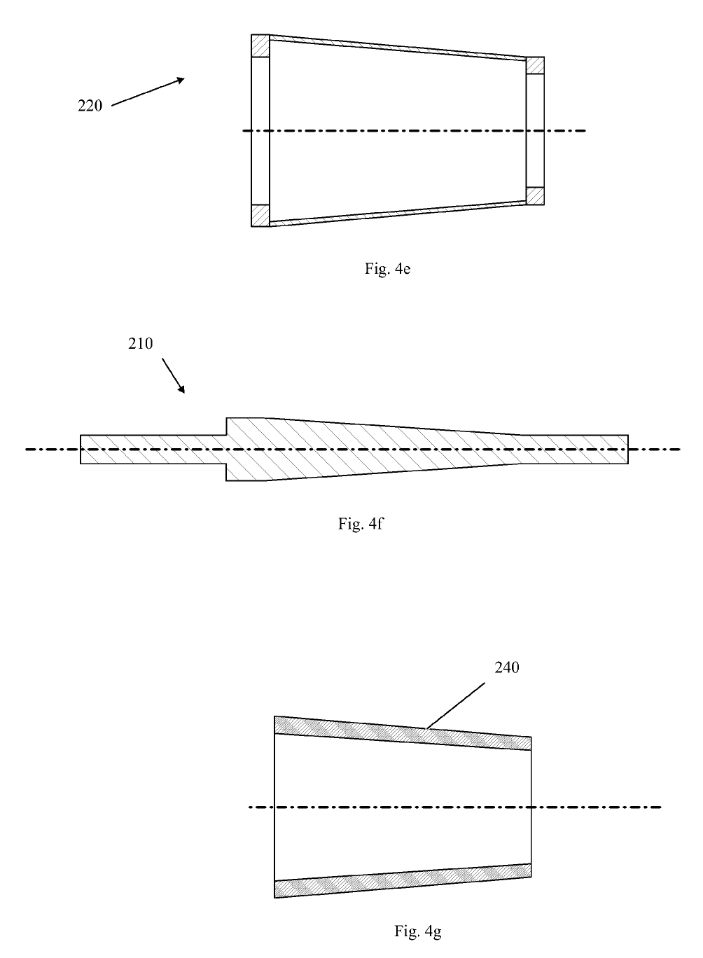

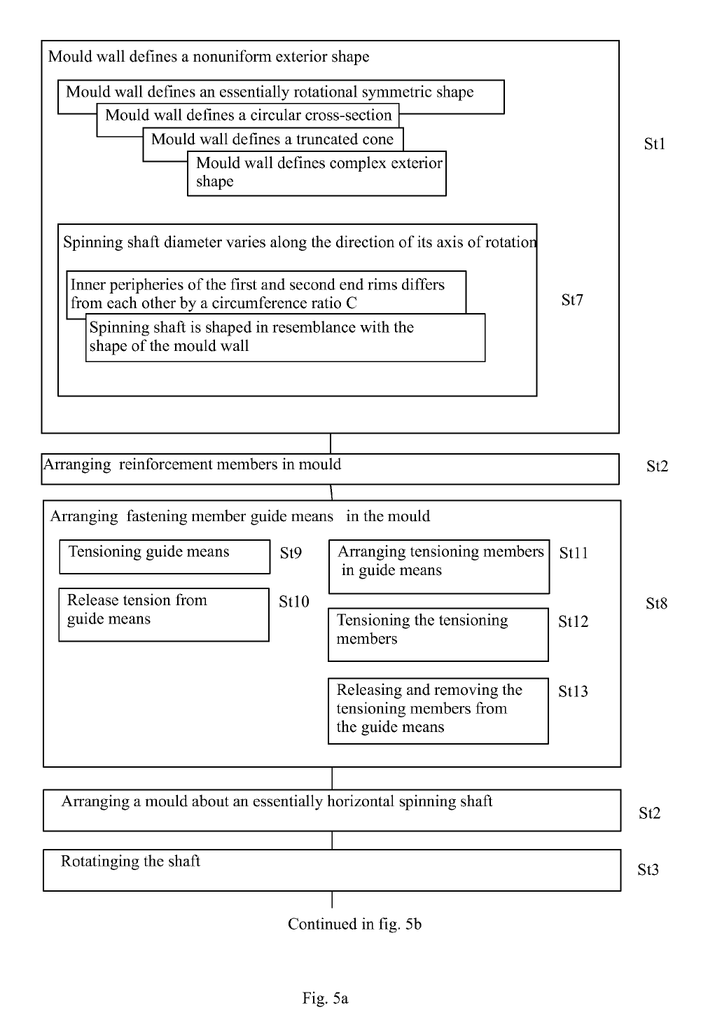

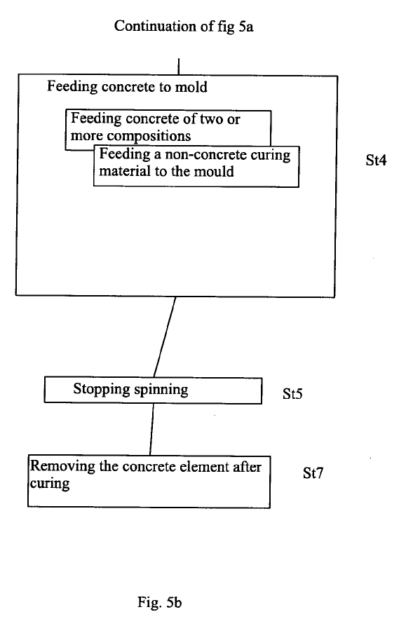

According to one embodiment schematically shown in the flow chart of FIGS. 5a and 5b and depicted in FIGS. 4a to 4d and, there is provided a method of making such open-ended hollow concrete element comprising the steps:
arranging a mould about an essentially horizontal roller shaft, St2, the mould comprising a sleeve-shaped mould wall defining the outer peripheral shape of the concrete element and a first and a second end rim each with an inner periphery smaller than the inner periphery of the mould wall at respective end and defining the end surfaces of the concrete element, the mould is rotatably supported by the roller shaft by abutment at the inner peripheries of the first and a second end rims so that the roller shaft upon rotation defines the inner peripheral shape of the concrete elements
rotating the shaft to rotate the mould, St3,
feeding curable concrete to the rotating mould, St4,
stopping the rotation of the mould, St5,
removing the cured concrete element from the mould, St6,
wherein the inner perimeter of the mould wall defines an exterior shape of the concrete element that varies along and/or radially to the direction of the rotational axis St1.

By the definition exterior shape of the concrete element that varies along and/or radially to the direction of the rotational axis, reference is made to any shape that is not a right circular cylinder such as the shape of conventional pipes. The so produced concrete elements may be of virtually any external shape as defined by the inner perimeter of the mould wall. In FIGS. 4a to 4d, the depicted concrete element that is produced is shaped as a truncated cone with an essentially constant wall thickness. The finished concrete element is shown in FIG. 4g.

FIGS. 4a to 4d schematically show one embodiment of an arrangement during steps of a method of producing an open-ended hollow concrete element. The arrangement 200 comprises an essentially horizontal roller shaft 210 and a mould 220 rotatably suspended on the roller shaft 210. The mould 220 comprises a sleeve-shaped mould wall 230 defining the outer peripheral shape of the concrete element 240 to be produced and a first 250 and a second 260 end rim each with an inner periphery, 251 and 261 respectively, smaller than the inner periphery of the mould wall 230 at respective end and defining the end surfaces of the concrete element 240. The mould 220 is rotatably suspended by the roller shaft 210 by abutment at the inner peripheries, 251 and 261 respectively, of the first 250 and a second 260 end rims so that the roller shaft 210 upon rotation defines the inner peripheral shape of the concrete element 240. The first 250 and a second 260 end rims abuts the roller shaft 210 at abutment sections 211 and 212 respectively, as indicated by dotted lines in FIG. 4a.

According to one embodiment, the inner perimeter of the mould wall 230 defines an exterior shape of the concrete element 240 that varies along and/or radially to the direction of the rotational axis, whereby the concrete elements 240 formed in the mould 220 will have a complementary external shape. According to the embodiment disclosed in FIGS. 4a to 4d, the mould wall 230 defines a truncated cone. However, the inner perimeter of the mould wall 230 may e.g be arranged to define a large variety of exterior shapes for the concrete element 240, such as an essentially rotational symmetric shape or a circular cross-section along the direction of its axis of rotation. Moreover, the mould wall 230 may be arranged to define a complex exterior shape of the concrete element 240 as well as different types of external textures, as will be discussed more in detail below.

The roller shaft 210 is in turn rotatably supported by bearings 270 and 280. In the disclosed embodiment, the roller shaft is supported by bearings 270, 280 on both sides of the mould 230, but in an alternative embodiment (not shown), the roller shaft is supported by one or more bearings only at one end thereof. The bearings 270 and 280 may be of any suitable type that allows rotation of the roller shaft and that are designed to carry the load of the rotating mould 220 when it is filled with concrete. The roller shaft 210 is driven for rotation by a suitable motor arrangement (not shown) capable of providing the desired speed of rotation when the mould 220 is filled. During rotation of the roller shaft 210, and consequently the mould 220, the centrifugal force acting on the concrete in the mould may be from less than approx. 2G to more than approx.6G. Generally, the roller shaft 210 has a small diameter, compared to the inner periphery of the end rims 251 and 261 respectively.

According to one embodiment, like in FIGS. 4a to 4d, the diameter of the roller shaft 210 varies along the direction of its axis of rotation. As is disclosed in FIGS. 4a to 4d the circumference of the inner peripheries of the first and second end rims 251, 261 differs from each other by a circumference ratio C and wherein the diameters of the roller shaft at the respective abutment sections 211, 212 differs from each other by the ratio C. In this way, there will be no slipping between the roller shaft 210 and the end rims 251, 261 that would cause wear and possibly unbalanced behaviour of the arrangement. The inner peripheries of the end rims 251, 261 and the outer peripheral shape of the abutment sections 211, 212 are preferably circular, but they may be of other shapes, provided that an essentially balanced behaviour is achieved. According to one embodiment, the compacting section 213, i.e. the section between the abutment sections 211, 212 of the roller shaft 210 is shaped in resemblance of the shape of the mould wall 230. This embodiment provides a concrete element with essentially uniform wall thickness wherein the shape defined by the mould wall is of circular cross-section. However, by synchronizing the rotational movement of the roller shaft 210 and the mould 220 a radially shaped non circular inner periphery of the finished concrete element that is in conformity with the outer peripheral shape may be provided.

According to one embodiment, the roller shaft 210 is provided with an essentially smooth surface to provide a smooth inner surface in the open-ended concrete element 240. However, it may be provided with a textured surface, e.g. to have a non smooth inner surface to increase friction or the like. For certain concrete compositions it has been found that there may be allowed a slipping contact between the compacting section 213 of the roller shaft and the inner peripheral surface of the cement element during rotation, and it may even be advantageous as the surface might achieve a high degree of finishing.

In FIGS. 4a to 4d there is provided a conveyor belt 290 for feeding the mould 220 with uncured concrete etc. However, the concrete may be feed to the mould by any suitable feeding means 290, such as by hand, a screw feeder, vibrating chute or the like. The feeding means 290 may be stationary and feed concrete to one or more positions or it may be moveable so as to feed concrete at desired positions in the mould 220, as is disclosed in FIGS. 4b and 4c. The feeding means 290 is controlled to feed uncured concrete to the mould 220 until the desired wall thickness and compaction rate is achieved. Thereafter, the mould 220 is rotated for a predetermined curing time so that the concrete is sufficiently cured to allow removal of the concrete element 240 from the mould and subsequent handling.

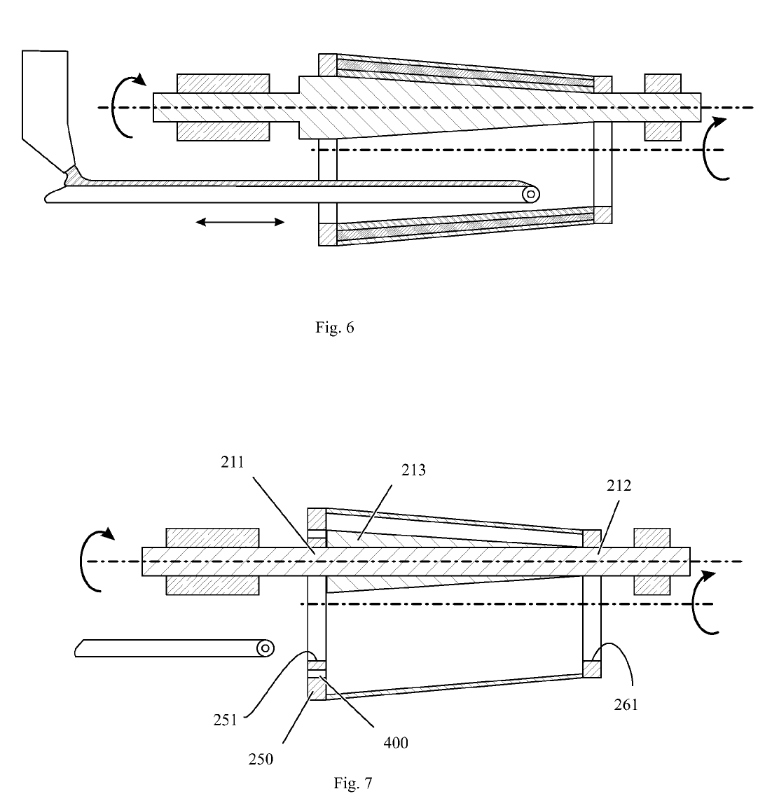

Due to the disclosed method, the concrete that is supplied to the mould may have a very low water content, which in some situations may be referred to as dry concrete. The so supplied concrete is compacted by centrifugal force and by the roller shaft. Example of materials for the purpose of this invention includes, steel fibrous cement based composites i.e. concrete blended metal mesh and/or rebar. Other materials are also to be considered able, are such as, but not limited to, metal, plastics, cement based materials, wood, glass, carbon fibre and composites of the same. According to one embodiment at least a portion of the concrete fed to the mould 220 is fibre armed concrete. According to one embodiment schematically disclosed in FIG. 6, step of feeding St4 comprises feeding concrete of two or more compositions. There may further be provided a step of feeding a non-concrete material to the mould, such as a plastic or fibre composite material. Said non-concrete material may be a cureable material or it may be another material that is adhered to the concrete or the like. The material may e.g. be provided to provide an esthetical effect or a functional effect to the concrete element or the like.

FIG. 4e shows a cross-sectional view of the mould 220 in FIGS. 4a to 4d in the plane of its axis of rotation. Likewise, FIG. 4f shows a cross-sectional view of the rolling shaft 210 in the plane of its axis of rotation.

According to one embodiment, disclosed in FIG. 7, the inner diameter of at least one end rim 251 is smaller than the inner periphery of the concrete element 240 to be moulded at that end. In the disclosed embodiment, the inner diameters of both end rims are equal, whereby the diameters of the abutment sections of the roller shaft 211, 212 should be equal. The compacting section 213 of the roller shaft is shaped to form the inner periphery of the concrete element 240 of the predetermined wall thickness. In the disclosed embodiment, the compacting section 213 of the roller shaft is essentially cone shaped with a vertical base section by one end rim 250. In order to make the moulding arrangement more versatile, the compacting section 213 of the roller shaft may be provided as a detachable compacting member. Hence, the roller shaft 210 need not to be replaced together with the mould when a concrete element 240 of different shape is to be produced. In one embodiment, the end rim 250 adjacent the vertical base section of the compacting section 213 is provided with at least one overflow opening 400 arranged to allow overflow of excess uncured concrete and/or water or the like.

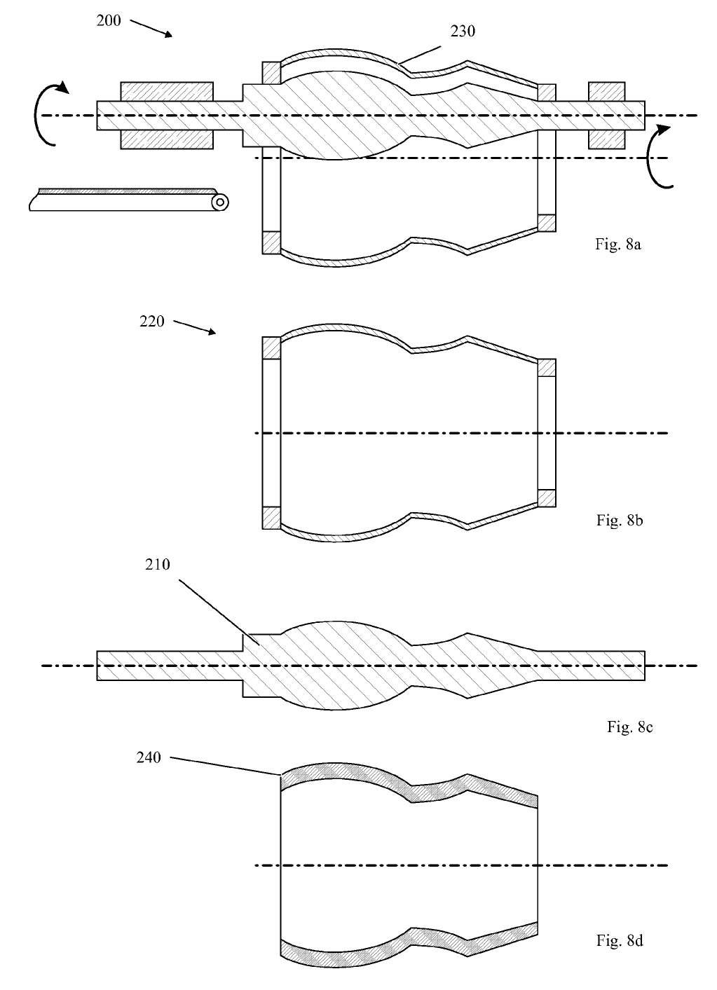

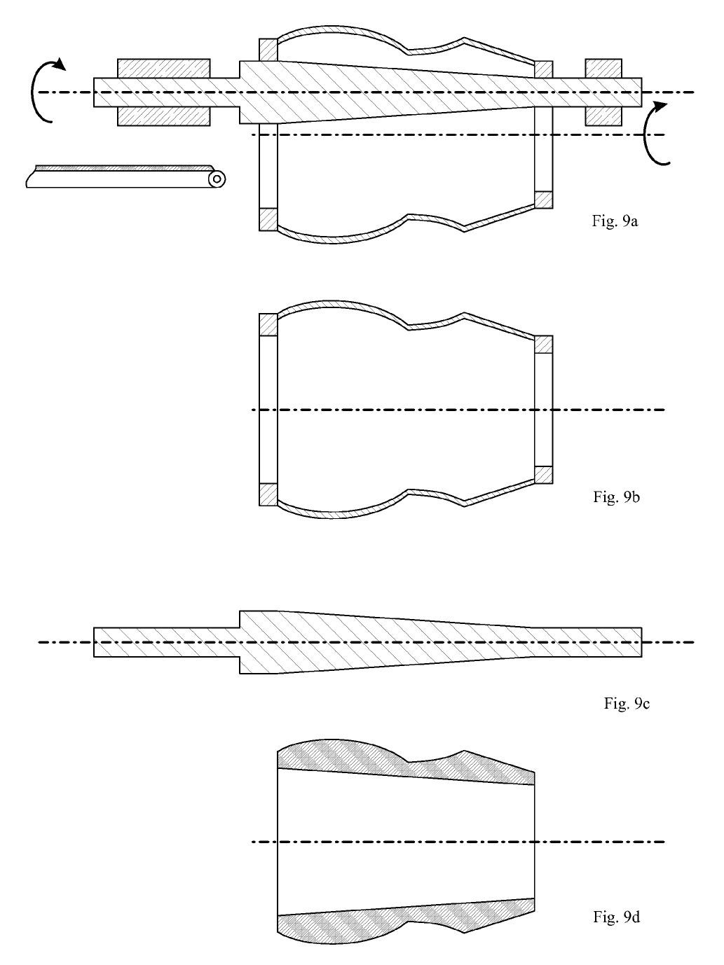

FIGS. 8a to 8d shows a moulding arrangement for forming open-ended hollow concrete elements 240 of more complex shape compared to the previous embodiment. In this embodiment, the roller shaft 210 is shaped to essentially resemble the shape of the mould wall 230, in order to achieve a concrete element 240 of essentially uniform wall thickness. FIGS. 9a to 9d shows a similar moulding arrangement 200 but wherein the roller shaft 210 is not shaped to resemble the mould wall 230, whereby the wall thickness varies along the length of the concrete element. According to one embodiment, not shown, the compacting section 213 of the roller shaft 210 is uniform along its length.

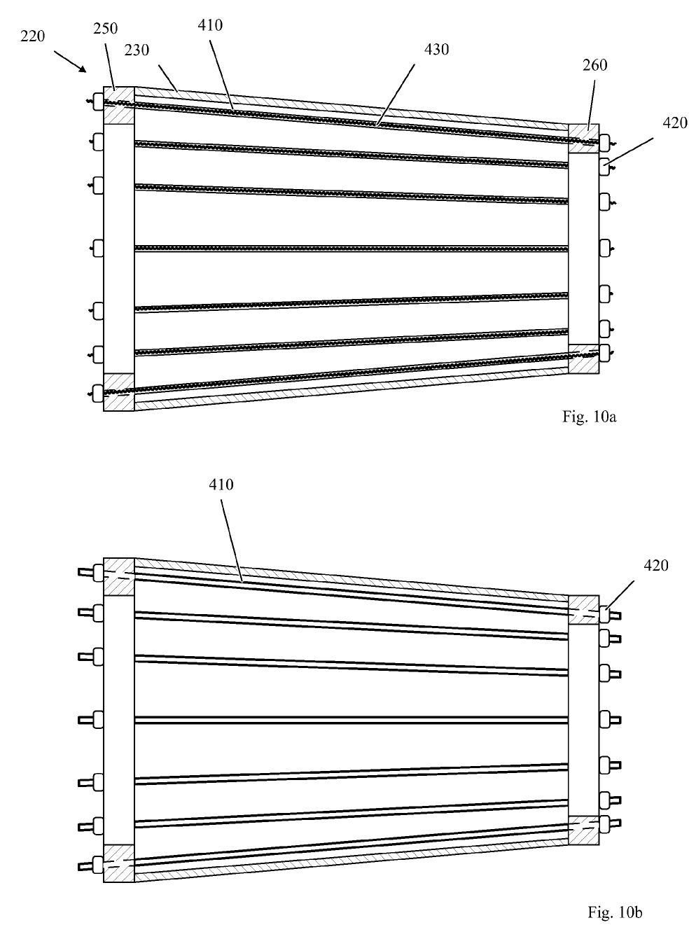

According to one embodiment, schematically disclosed in FIGS. 10a and 10b, a plurality of fastening member guide means 410 (St3) are arranged at predetermined positions in the mould 220, each extending between the end rims 250 and 260 respectively. In order to avoid deformation, such as bending of the guide means, during moulding, the guide means 410 may be tensioned St9 with a predetermined force. Hence, the tension need to be released St10 before removing the cured concrete element from the mould. According to one embodiment, disclosed in FIG. 10b, the guide means 410 are rigid and the tension may be applied directly to the guide means 410 by fastening members 420 or the like. According to another embodiment, disclosed in FIG. 10a, the guide means are tensioned by arranging St11 tensioning members 430 in the guide means, and tensioning St12 said tensioning members with a predetermined force, using fastening members 420 or the like. Like above, the tensioning members 430 have to be removed St13 from the guide means 410 before removing the cured concrete element from the mould 220. The guide means 410 may be any suitable element that can provide guidance for fastening members 20 when assembling an elongated concrete structure according to FIG. 1, such as hollow tubes or the like. According to one embodiment, at least one of the end rims 250, 260 is arranged to define a fastening member attachment point 40 at one or more of the guide means 410.

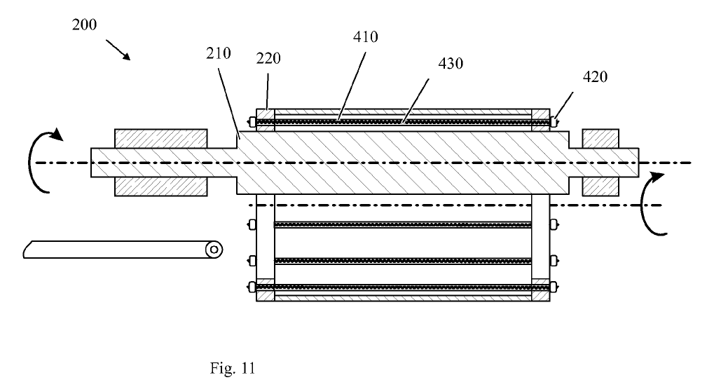

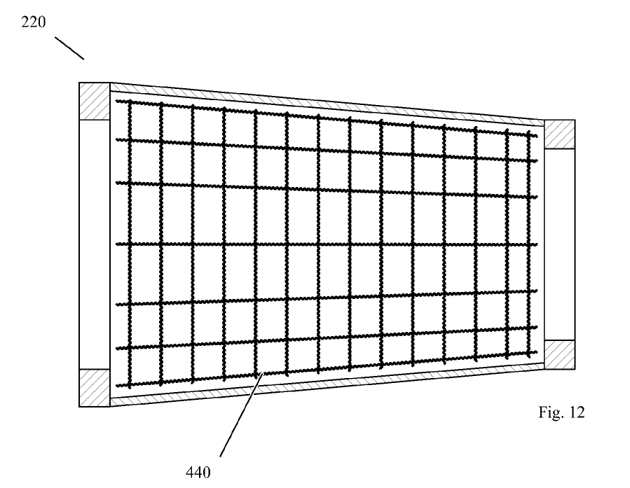

FIG. 11 discloses one embodiment of an arrangement for making concrete elements 200 of uniform external shape with guide members 410. The corresponding method of making an open ended hollow concrete element comprises the steps:
arranging a mould 220 about an essentially horizontal roller shaft 210, rotating the shaft to rotate the mould
feeding concrete to the rotating mould 220
stopping the rotation of the mould 220,
removing the cured concrete element 240 from the mould 220,
wherein the method prior to the step of arranging the mould about the roller shaft comprises the step of:
arranging a plurality of fastening member guide means 410 (St3) at predetermined positions in the mould 220, extending between the end rims 250, 260.

Whereas the guide members 410 provides the possibility of tension arming the finished elements, some embodiments may require additional reinforcement arming, in the radial and or the longitudinal direction depending. According to one embodiment, schematically disclosed in FIG. 12, a reinforcement network 440 is arranged in the mould.

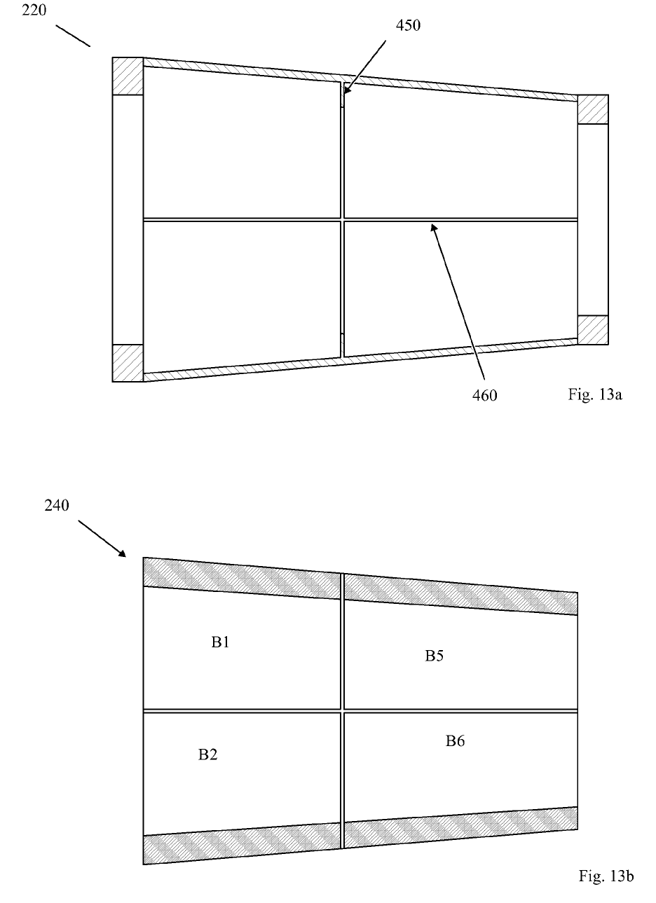

According to one embodiment, schematically disclosed in FIGS. 13a and 13b, the mould 220 comprises one or more radial section dividers 450 arranged to divide the concrete element 240 in one or more axial element sections. According to still one embodiment, also schematically disclosed in FIGS. 13a and 13b the mould 220 comprises one or more axial section dividers 460 arranged to divide the concrete element in one or more radial element sections. The sectioned concrete element shown in FIG. 13b shows one example of how the radial base segments B1 to B8 of base sections S1 and S2 in the elongated hollow concrete structure of FIG. 2.

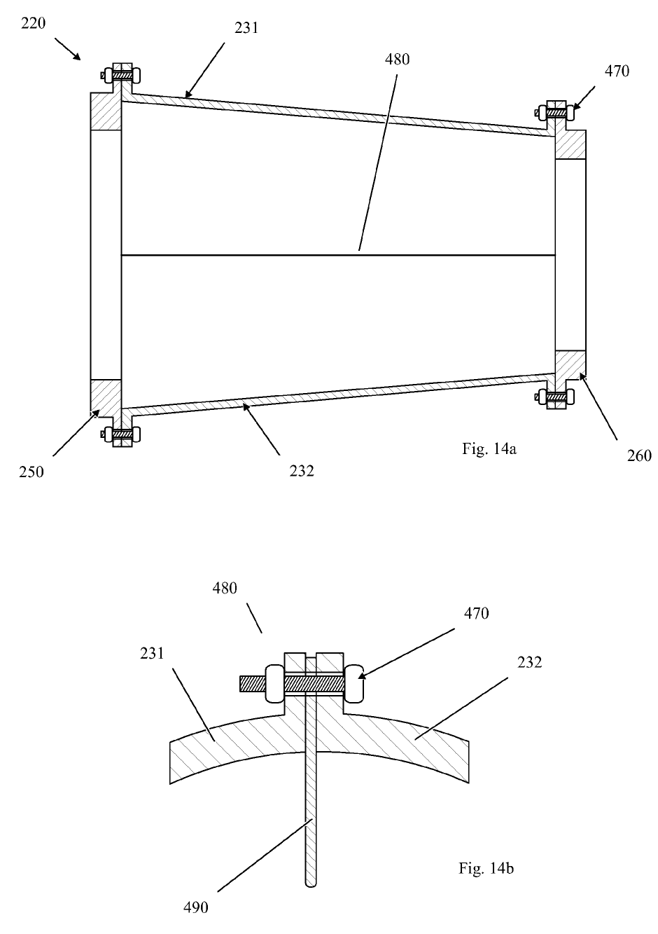

In order to facilitate removal of the cured concrete element the mould 220 may be detachable in at least two parts. FIG. 14a schematically shows one embodiment of a detachable mould 220, wherein the end rims 250, 260 are detachably attached to two or more mould wall sections 231 and 232 respectively, by bolts 470 or the like. FIG. 14b shows one example of a detachable joint 480 between two mould wall sections 231 and 232 respectively, wherein an axial section divider 490 is arranged to divide the concrete element 240 is attached by the joint 480.

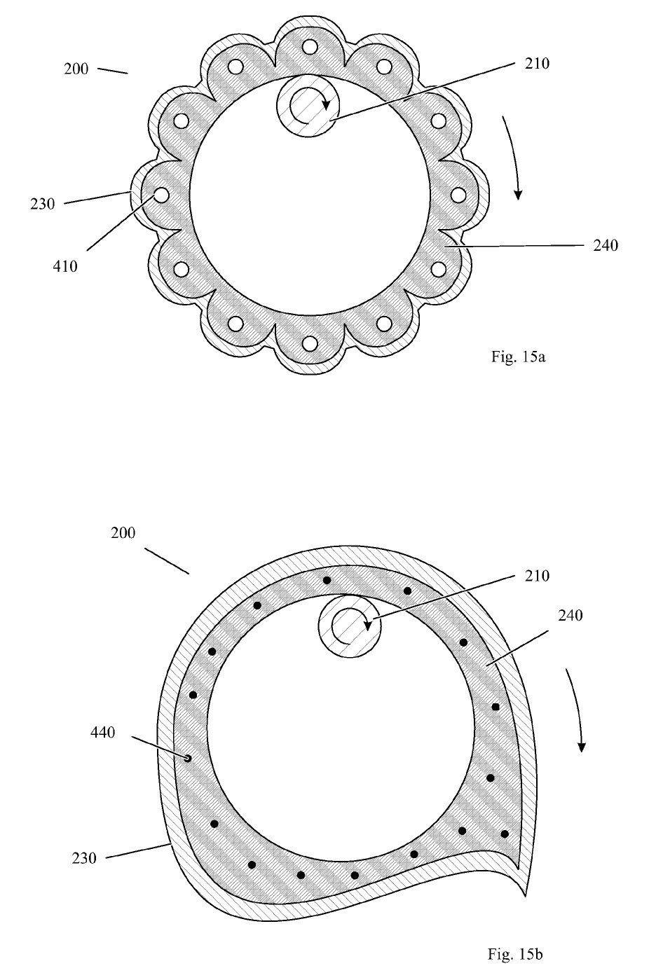

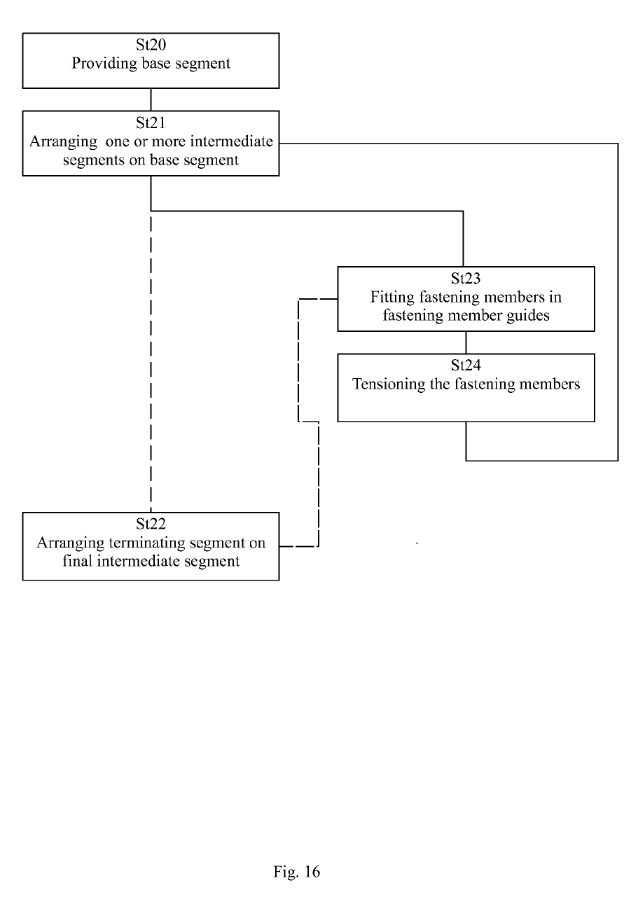

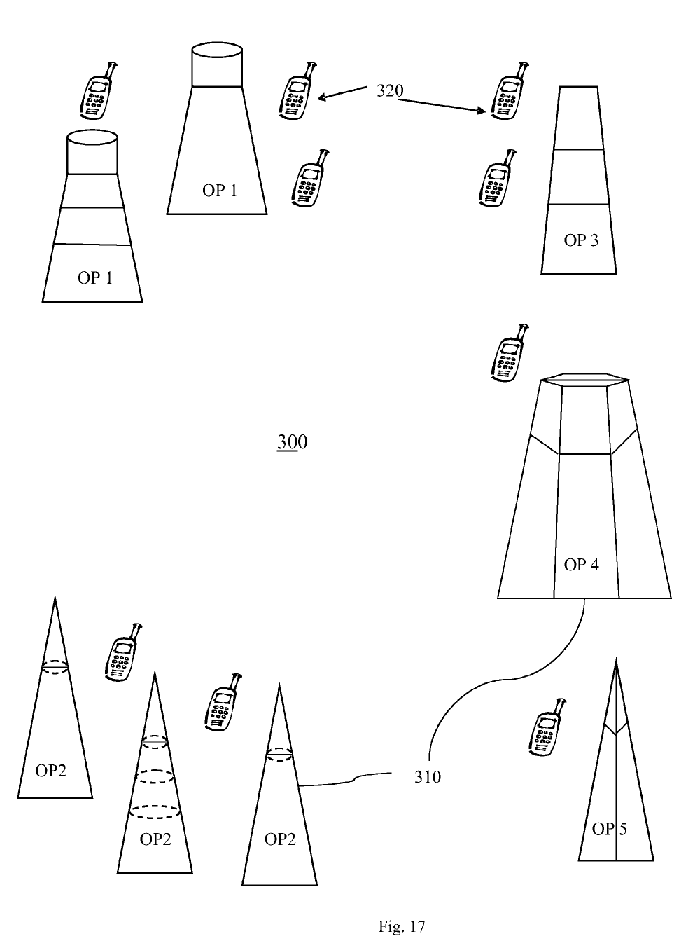

FIG. 15a discloses an example of a moulding arrangement 200 with a mould wall 230 defining a rotational symmetric shape in cross-section. In the disclosed embodiment, guide means 410 are symmetrically arranged in the concrete element. Whereas the disclosed embodiment is 12-fold rotational symmetric, essentially any rotational symmetrical shape may be provided from 2-fold and up. FIG. 15b discloses an example of a moulding arrangement 200 with a mould wall 230 defining a non symmetric or complex shape in cross-section. As is schematically indicated, the cross-sectional shape may be of essentially any shape, but it might be necessary to balance the mould in order to produce such elements.

According to one embodiment, the concrete elements are formed to be assembled to an elongated structure by a method of assembling a segmented elongated structure according to FIG. 1 that is comprised of open ended hollow concrete elements made in accordance with the present invention, comprising the steps:
ST20. providing a base segment comprising a plurality of attachment points for attachment of fastening members,
ST21. arranging one or more intermediate segments on the base segment, each intermediate segment comprising fastening member guides arranged to preserve fastening members at predetermined configuration with respect to the segment and optionally one or more attachment points for attachment of fastening members,
ST22. arranging a terminating segment on the final intermediate segment, the terminating segment comprising one or more attachment points,
ST23. fitting fastening members in the fastening member guides, extending between attachment points in a preceding segment and attachment points in a subsequent segment, and
ST24. tensioning the fastening members.

According to one embodiment, the method further comprises the step: securing a radio base station with associated antennas in the installation shaft of one of the prefabricated elongated antenna tower segments before said segment is interconnected.

FIG. 17 is a block diagram illustrating a system for wireless communication in accordance to an embodiment of the present invention. The wireless communications system 300 comprises one or more antenna tower structures 310 each equipped with at least one antenna Radio Base Station serving as an access point for user equipments 320. The antenna tower structures of the system are being cast and divided into tubular tower sections having a hollowed cross section. The sections are equipped with an arrangement for moving a whole antenna radio base station along the elongation of the antenna tower structure, wherein the antenna radio base station is being disposed inside the tubular tower. Each antenna tower structure have at least one entrance into the antenna tower structure giving access for service of the antenna Radio Base station. The system 30, permits operator specific antenna tower structure designs (OP1, OP2, OP3, OP4, OP5 etc).

In a further embodiment, operator specific designs makes it more simple for service personnel to identify a specific antenna tower structure among other towers, wherein equipment in the tower is to be served, updated or reconfigured.

While the invention has been described with reference to specific exemplary embodiments, the description is in general only intended to illustrate the inventive concept and should not be taken as limiting the scope of the invention.

It will be understood by those skilled in the art that various modifications and changes may be made to the present invention without departure from the scope thereof, which is defined by the appended claims.

1.-34. (canceled)

35. A method of making an open ended hollow concrete element, comprising:
arranging a mold about a substantially horizontal roller shaft, the mold comprising a sleeve-shaped mold wall defining an outer peripheral shape of the concrete element and first and second end rims, each having an inner periphery smaller than an inner periphery of the mold wall at the respective end and defining end surfaces of the concrete element, the mold being rotatably supported by the roller shaft by abutment at the inner peripheries of the first and second end rims so that the roller shaft upon rotation defines an inner peripheral shape of the concrete elements;
rotating the shaft to rotate the mold;
feeding curable concrete to the rotating mold;
stopping rotation of the mold; and
removing the cured concrete element from the mold;
wherein an inner perimeter of the mold wall defines an exterior shape of the concrete element that varies along a direction of a rotational axis and/or radially to the direction of the rotational axis, and the roller shaft has different diameters along a direction of its axis of rotation.

36. The method of claim 35, wherein the circumferences of the inner peripheries of the first and second end rims differ from each other by a ratio C, and the diameters of the roller shaft at the respective abutment sections differ from each other by the ratio C.

37. The method of claim 35, wherein the roller shaft is shaped in resemblance with the shape of the mold wall.

38. The method of claim 37, wherein the mold wall has a substantially rotationally symmetric shape.

39. The method of claim 38, wherein the mold wall has a circular cross-section along the direction of its axis of rotation.

40. The method of claim 39, wherein the mold wall defines a truncated cone.

41. The method of claim 35, further comprising, before arranging the mold about the roller shaft, arranging a plurality of fastening member guide devices at predetermined positions in the mold, each guide device extending between the end rims.

42. The method of claim 41, further comprising tensioning the guide devices with a predetermined force before removing the cured concrete element from the mold, releasing tension from the guide devices.

43. The method of claim 41, further comprising arranging tensioning members in the guide devices, and tensioning the tensioning members with a predetermined force before removing the cured concrete element from the mold, releasing and removing the tensioning members from the guide devices.

44. The method of claim 41, wherein the guide devices are tubes.

45. The method of claim 41, wherein one of the end rims defines a fastening member attachment point at one or more of the guide devices.

46. The method of claim 35, further comprising, before arranging the mold about the roller shaft, arranging a reinforcement network in the mold.

47. The method of claim 35, wherein the at least a portion of the concrete fed to the mold is fiber-reinforced concrete.

48. The method of claim 35, wherein feeding comprises feeding concrete of two or more compositions.

49. The method of claim 35, further comprising feeding a non-concrete curing material to the mold.

50. The method of claim 35, wherein the mold comprises one or more radial section dividers arranged to divide the concrete element into one or more axial element sections.

51. The method of claim 35, wherein the mold comprises one or more axial section dividers arranged to divide the concrete element into one or more radial element sections.

52. The method of claim 35, wherein the mold is detachable in at least two parts to facilitate removal of the cured concrete element.

53. An arrangement for making an open ended hollow concrete element, comprising:
a substantially horizontal roller shaft; and
a mold, comprising a sleeve-shaped mold wall defining an outer peripheral shape of the concrete element and first and second end rims, each having an inner periphery smaller than an inner periphery of the mold wall at the respective end and defining end surfaces of the concrete element, wherein the mold is rotatably supported by the roller shaft by abutment at the inner peripheries of the first and second end rims so that the roller shaft upon rotation defines an inner peripheral shape of the concrete element;
wherein the roller shaft has a diameter that varies along a direction of its axis of rotation, and an inner perimeter of the mold wall defines an exterior shape of the concrete element that varies along the direction of the rotational axis and/or radially to the direction of the rotational axis.

54. The arrangement of claim 53, wherein the circumferences of the inner peripheries of the first and second end rims differ from each other by a ratio C, and the diameters of the roller shaft at the respective abutment sections differ from each other by the ratio C.

55. The arrangement of claim 53, wherein the roller shaft is shaped in resemblance with the shape of the mold wall.

56. The arrangement of claim 53, wherein the mold wall defines a substantially rotationally symmetric shape.

57. The arrangement of claim 56, wherein the mold wall defines a circular cross-section along the direction of its axis of rotation.

58. The arrangement of claim 57, wherein the mold wall defines a truncated cone.

59. The arrangement of claim 53, wherein the mold comprises one or more radial section dividers arranged to divide the concrete element into one or more axial element sections.

60. The arrangement of claim 59, wherein the mold comprises one or more axial section dividers arranged to divide the concrete element into one or more radial element sections.

61. The arrangement of claim 53, wherein the mold is detachable in at least two parts to facilitate removal of the cured concrete element.
